(19) United States
(12) Patent Application Publication
(10) Pub. No.: US 2006/0159251 A1
(43) Pub. Date: Jul. 20, 2006

(54) Centralized call transfer method and system

(76) Inventors: Michel Guillard, Cachan (FR); Pierre Saude, Viroflay (FR); Frederic Vicendo, Andresy (FR)

Correspondence Address: MILES & STOCKBRIDGE PC, 1751 PINNACLE DRIVE, SUITE 500, MCLEAN, VA, 22102-3833, US

(21) Appl. No.: 11/292,284

(22) Filed: Dec. 2, 2005

(30) Foreign Application Priority Data
Dec. 6, 2004 (FR) 04 12968

(51) Int. Cl. H04M 3/42

(52) U.S. Cl. 379/212.01

(57) ABSTRACT

Call transfer method for transferring a call in progress between a first terminal (A) and a second terminal (B) by means of a telecommunication network (1), to a third terminal (C), which method includes steps in which: a call (11) is established between the first and the second terminal; the second terminal places the call with the first terminal on hold, and calls a call transfer server (3) connected to the network; once a call (12) is established between the second terminal and the server, the second terminal provides the server with a telephone number of the third terminal; the server transmits an order to establish a call (14) with the third terminal; when the third terminal answers, it is put in communication with the first terminal, and the calls of the second terminal with the network and the call transfer server are interrupted.

This invention relates to telephone services and, more specifically, to call transfer services enabling a first correspondent in telephone communication with a second correspondent to transfer the call in progress to a third correspondent located at a different site.

It applies in particular, but not exclusively, to so-called “intelligent” telephone networks in which one of the two correspondents in communication accesses the telephone network by means of PABX (Private Automatic Branch exchange), IVS (Interactive Voice Server) or ACD (Automatic Call Distribution) equipment.

Currently, the most widely-used technique for transferring a telephone call established between two correspondents to a third correspondent consists of using what is called a call connection at the site of the first of the two correspondents in communication. This technique consists of generating a second call to a third correspondent, at the level of the equipment (PABX, IVS or ACD) of the first correspondent of the call, and then putting the second correspondent in communication with the third correspondent, using the equipment. This technique can be applied to so-called “attended” call transfers, i.e. with the possibility of a prior conversation between the first and third correspondent, as well as to so-called “blind” call transfers, i.e. without this prior call.

This technique has the disadvantage of requiring the equipment to establish two calls during the entire call with the third correspondent, which involves the additional consumption of connection capacities at the equipment level, as well as the cost of an additional call.

There is also a so-called rerouting call transfer technique which is applicable to both attended and blind transfers. This technique consists of transmitting to the network, from the equipment (PABX, IVS or ACD) of the first of the two correspondents in communication, a transfer command (also called “call rerouting”). This command is interpreted by the network, which establishes a call to the third correspondent and which puts the latter in communication with the second correspondent. The first correspondent connected to the equipment is then released from the call, so that there is now only one call. In ISDN (Integrated Services Digital Network) networks, this transfer command is encapsulated in the “facility” message provided by the ISDN protocol or transmitted in the band via a DTMF (Dual-Tone Multi-Frequency) sequence). However, PABX cannot transmit a “facility” message; only an IVS is capable of managing such a message. In addition, the use of a DTMF sequence makes it necessary to maintain DTMF detectors in the network for the entire duration of the call so as to be capable of interpreting a possible transfer command transmitted by one of the correspondents. However, such detectors are expensive voice resources.

The aim of this invention is to overcome these disadvantages by proposing a blind or assisted call transfer mechanism that can be activated with the basic functions provided in most existing PABX, ACD and IVS equipment. This objective is achieved by providing a call transfer method for transferring a call in progress between a first terminal and a second terminal by means of a telecommunications network, to a third terminal, which method includes preliminary steps in which the terminal dials a telephone number of the second terminal, the number is processed by the network so as to route the call to the second terminal and thus establish a call between the first and second terminal.

According to the invention, this method includes steps in which:
the second terminal puts the call with the first terminal on hold, and calls a call transfer server connected to the network,
once a call is established between the second terminal and the call transfer server, the second terminal provides the call transfer server with a telephone number of a third terminal to which the call is to be transferred,
the call transfer server transmits to the network a command to establish a call with the third terminal, and
when the third terminal answers, it is put in communication with the first terminal, and the calls of the second terminal with the network and the call transfer server are interrupted.

According to an embodiment of the invention, when the call is established between the first and the second terminal, the network assigns a call identifier to the call, which is transmitted to the second terminal, and once the call is established between the second terminal and the call transfer server, the second terminal provides the call transfer server with the identifier of the call between the first and the second terminal.

According to an embodiment of the invention, the network assigns a call identifier to the call if the telephone number dialed by the first terminal is a special telephone number of the second terminal.

According to an embodiment of the invention, the identifier of the call between the first and the second terminal is transmitted to the second terminal and to the call transfer server in the call signaling of the ISDN protocol, or in the form of DTMF signals.

According to an embodiment of the invention, a call is established between the second terminal and the third terminal by means of the call transfer server, after a command to establish a call with the third terminal has been transmitted to the network.

According to an embodiment of the invention, the second terminal switches between the call with the first terminal and the call with the third terminal by means of the call transfer server, after a command for a broker call has been transmitted by the second terminal.

The invention also relates to a call transfer server for transferring a call in progress between a first terminal and a second terminal by means of a telecommunication network, to a third terminal. According to the invention, the server includes processing means designed to:
receive a transfer command coming from the second terminal by means of the network, which transfer command comprises a telephone number of a third terminal to which the transfer is to be carried out,
transmit, to the network, a command to establish a call with the third terminal to which the transfer is to be carried out, after receiving the transfer command, and
detect the answering of the third terminal and, after this detection, order the network to establish the call between the third terminal and the first terminal, and to release the connection with the second terminal.

According to an embodiment, the processing means are also designed to receive, with the transfer command, an identifier of the call between the first and the second terminal.

According to an embodiment of the invention, the processing means are also designed to establish a call with the third terminal and to put the latter in communication with the second terminal.

According to an embodiment of the invention, the processing means are also designed to transmit voice messages to the second terminal.

According to an embodiment of the invention, the call transfer server includes means for connecting to an intelligent network service control point connected to the network, wherein the processing means are designed to send, to the service control point, call routing commands, call transfer commands and call release commands, and to receive from the service control point call release signals and failure notices after an order to establish a call.

The invention also relates to a terminal including:
means for connecting to a telecommunication network,
means for establishing a call with a second terminal by means of the telecommunication network, and
call hold command means whereby a call established with the second terminal by means of the telecommunications network is put on hold.

According to the invention, the terminal also includes:
means for receiving a call identifier after establishing the call with the second terminal, and
means for calling a call transfer server connected to the network, and for transmitting to the latter the call identifier, and a telephone number of a third terminal, after the second terminal is put on hold.

The invention also relates to a service control point controlling a transit switch of a telecommunication network in command to provide Intelligent Network services, including means for controlling the transit switch so that it establishes a call with a terminal connected to the network, by means of a local exchange of a network, to which the terminal is connected. According to the invention, the connection point also includes:
means for receiving a special call number transmitted by a first terminal so as to establish a call with a second terminal,
means for translating the special number received into a telephone number of the second terminal, and
means for assigning a call identifier to the call between the first and the second terminal, after the special number of the second terminal has been received.

Thus, in terms of the network, the initial call between terminals A and B has been transformed into a single call between terminals A and C, without requiring the equipment 5 of terminal B to process any particular signaling.

A preferred embodiment of the invention will be described below, by way of a non-limiting example, with reference to the appended drawings, in which:

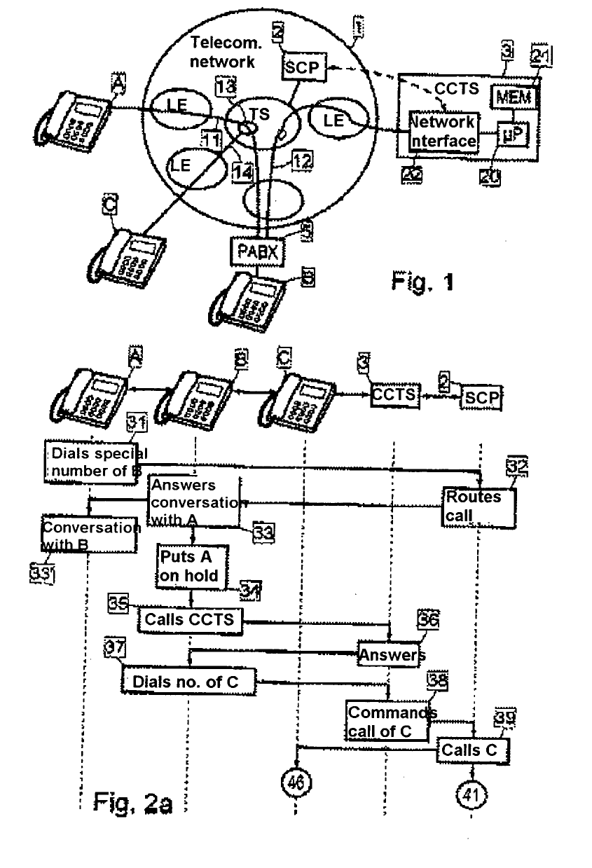

FIG. 1 diagrammatically shows a telephone network to which various subscribers are connected, as well as a call transfer system according to the invention;

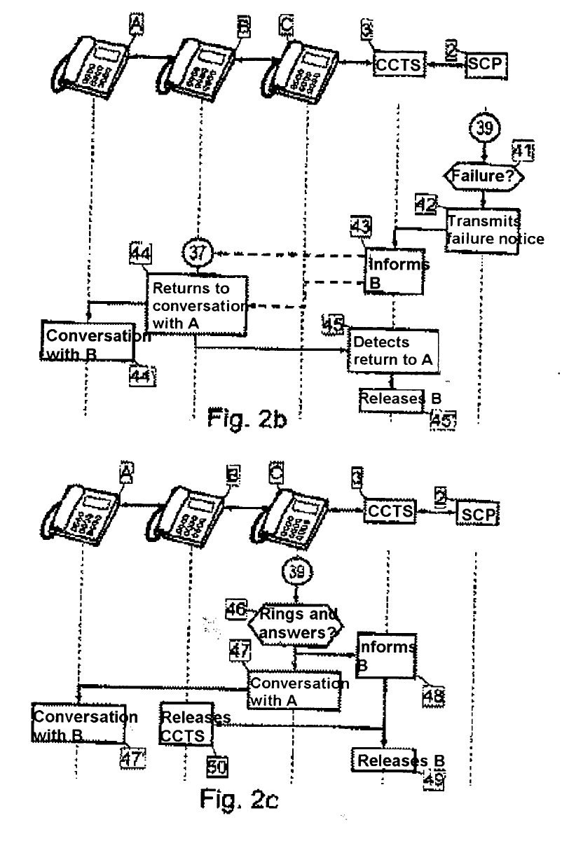

FIGS. 2a to 2c show, in the form of flowcharts, different steps of the method according to the invention, implemented by the call transfer system shown in FIG. 1;

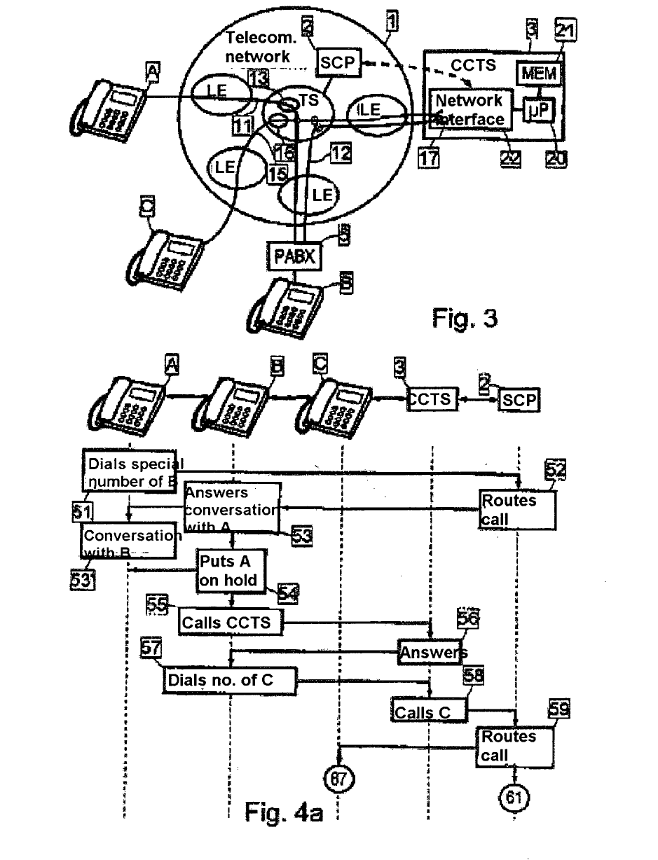

FIG. 3 diagrammatically shows a telephone network to which various subscribers are connected, as well as a call transfer system according to an alternative of the invention;

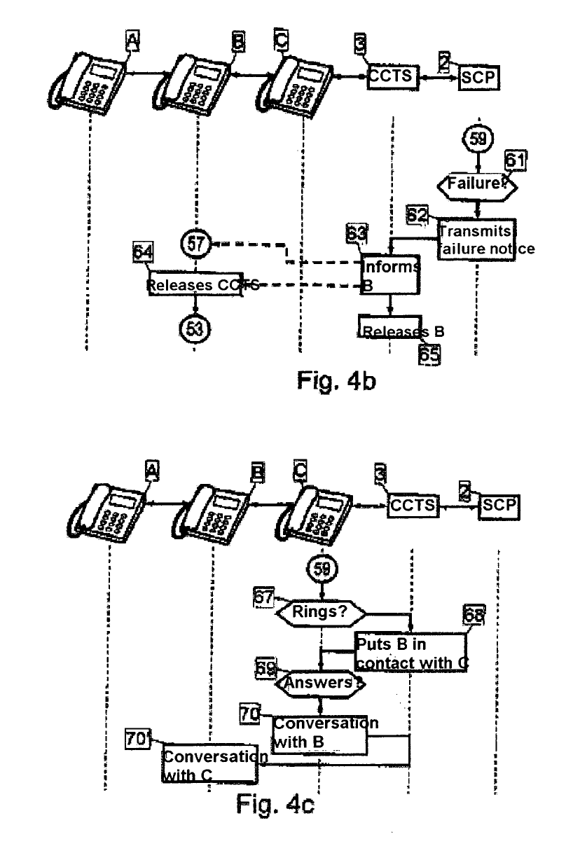

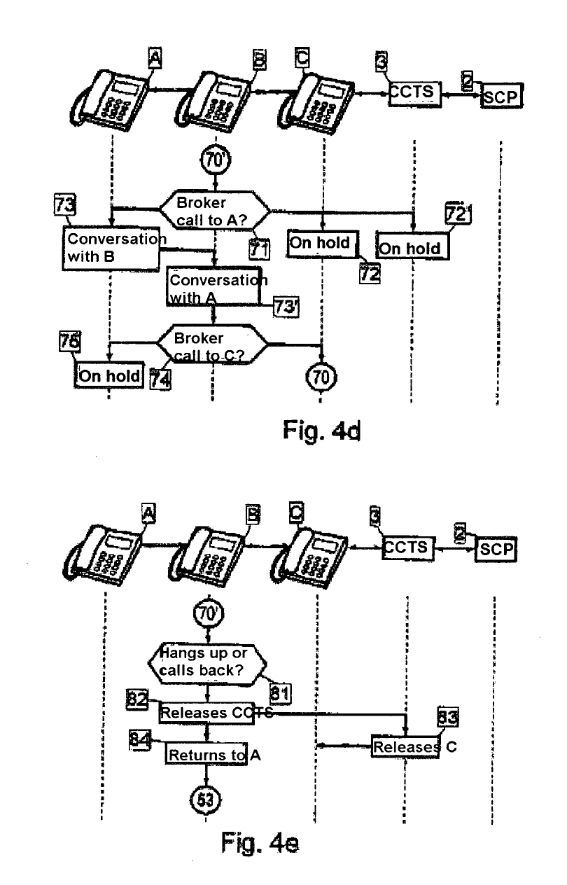

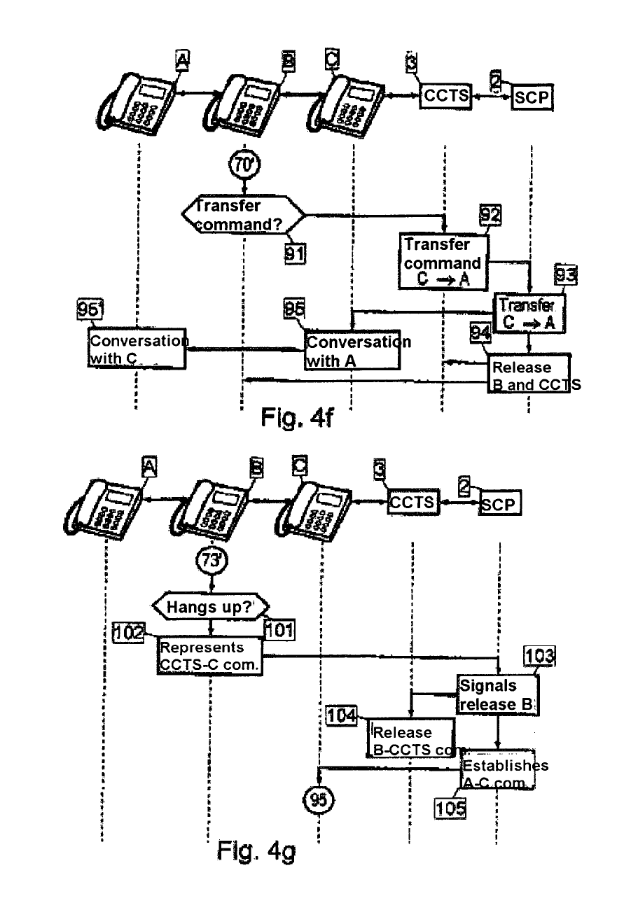

FIGS. 4a to 4g show, in the form of flowcharts, different steps of the method according to the invention implemented by the call transfer system shown in FIG. 3.

FIG. 1 shows a telephone network 1 to which different subscriber terminals A, B, C, are connected, wherein terminal B is connected to the network by means of PABX, IVS or ACD equipment 5. The network conventionally includes local exchanges LE for establishing connections with the subscriber terminals, a transit switch TS for establishing connections between the local exchanges LE, so as to establish a call between two subscriber terminals or more, and a Service control point (SCP) 2 controlling the transit switch TS so as to provide Intelligent Network services.

To provide a call transfer service, the invention implements a centralized call transfer server (CCTS) 3 connected to the network 1 by means of a local exchange LE, as well as to the SCP. Conventionally, the server 3 includes a processor 20, memories 21 and a network interface 22 designed to establish a plurality of simultaneous calls with the network 1.

The server 3 is designed and programmed to receive and interpret transfer requests received in voice form or DTMF signals, or else inserted in the so-called “user-to-user” ISDN signaling. The call transfer request received by the server 3 contains information enabling it to identify the call between two terminals A and B from which the call transfer request was transmitted, as well as the telephone number of the terminal C to which the call is to be transferred. Using this information, the server 3 transmits, to the network 1, a transfer command so as to establish a call between terminal C to which the call is to be transferred and one of the two terminals A, B in communication, from which the call transfer request was transmitted.

FIGS. 1 and 2a to 2c show the case of a blind call transfer according to the invention, i.e. without requiring terminal B, which transmitted the transfer command, to be put in communication with terminal C, to which the call is to be transferred.

The blind call transfer principle according to the invention is as follows. Terminal A dials an access number of terminal B, which is transmitted to the SCP. The SCP then assigns a call identifier to the call between terminals A and B, and orders the routing of the call of terminal A to terminal B by positioning, in the network signaling, the call identifier that it has assigned. This identifier is placed in the NDS field (Supplementary Designation Number) or UUS (User-to-User Signaling) field of the call signaling of the ISDN protocol.

The access to the SCP during the call initiated by terminal A can be achieved systematically, or, for example, using a special access number of terminal B, also called a service access number (SAN). The network is thus designed to recognize such special numbers and direct the corresponding calls to the SCP which translates these special numbers into telephone numbers, and assigns call identifiers to the corresponding calls.

Once the call between terminals A and B is established, the user of terminal B can transfer the call to a terminal C of another user connected to the network 1. To this end, he puts the calling terminal A on hold on his equipment 5 and calls the server 3. When the server 3 answers the call, the user of terminal B provides the server with the identifier of the call and the telephone number of terminal C to which the call is to be transferred. This information can be communicated with DTMF signals, in voice form, or by means of data exchanged in the UUS signaling of the ISDN protocol. The server 3 then transmits the transfer request to the network 1. Upon receipt of this request, the network establishes a half-call (leg) 14 to terminal C, i.e. a connection between the network and terminal C. When terminal C answers, terminal A which, has been on hold on the equipment 5 of terminal B is put in communication with terminal C. The half-call to terminal B (between the network and terminal B), which was established in order to put terminals A and B in contact, is then released. When terminal C answers, a call transfer report is transmitted by the network to server 3, then is communicated by the latter to terminal B, for example, in voice form.

Thus, in terms of the network, the initial call between terminals A and B has been transformed into a single call between terminals A and C, without requiring the equipment 5 of terminal B to process any specific signaling.

FIG. 2a shows the procedure for establishing a call between terminals A and B.

In the first step 31 of this procedure, the user of terminal A dials the special telephone number (SAN) of terminal B. This special number is detected by the transit switch TS which sends it to the SCP. In the next step 32, the SCP translates the special number received into a telephone number of terminal B, assigns an identifier to the call, and controls the transit switch TS so that it can establish a call between the local exchanges LE of terminals A and B. This operation results in the creation of a billing ticket 13 at the level of the transit switch or the SCP, and a call 11 between terminals A and B triggering the ringer of terminal B. If terminal B answers, it receives the NDS or UUS signaling containing the identifier of the call and is put in communication with terminal A (steps 33, 33′.

When the user of terminal B decides to transfer the call to terminal C, he orders, in step 34, his equipment 5 to place terminal A on hold, and dials the telephone number of the server 3 (step 35). This action results in the establishment, at the network level, of a call 12 between terminal B and the server 3. In the subsequent step 36, the server 3 answers and sends terminal B a voice message inviting the user to dial the call identifier received in step 33 and the number of the correspondent to whom the call is to be transferred.

In the next step 37, the user of terminal B dials the identifier of the call with terminal A and the telephone number of terminal C, using the keypad of the terminal, with a phone number extension (DTMF signals). This information is received in the next step 38 by the server 3 which transmits a command to the SCP to establish a call with terminal C. This command is received in step 39 by the SCP which controls the transit switch TS so that it can establish a call 14 with terminal C in conjunction with the billing ticket 13 corresponding to the call of terminal A to terminal B.

The procedure continues as shown in FIG. 2b in the event of a failure to establish the call with terminal C, i.e. if terminal C is busy or if the telephone number of terminal C is incorrect, or if terminal C does not answer after a predefined time period (step 41). In the next step 42, the SCP transmits a failure notice to the server 3. In the next step 43, the server then transmits this failure notice in voice form to terminal B. The user of terminal B then has two options: either to repeat the procedure starting at step 37 by redialing the telephone number of terminal C or of another terminal, or to return to the conversation with the user of terminal A. This latter option is performed by means of a call-back command applied to the equipment 5 of terminal B (step 44). The terminals A and B are then in communication again in steps 44, 44′. This call-back command is also detected in step 45 by the server 3, which can then decide after a predefined time period to terminate the call with terminal B (step 45′).

If, after step 39, terminal C rings, the procedure will continue according to FIG. 2c. If, in step 46, terminal C answers, it will be in communication with terminal A (steps 47, 47′), and the server 3 detects this and informs terminal B of it via a voice message in step 48. In the subsequent steps 49, 50, the server 3 releases the call with the terminal B and vice versa.

FIGS. 3 and 4a to 4g show the case of an attended call transfer according to the invention, i.e. in which terminal B which has transmitted the call transfer command can communicate with terminal C to which the call is to be transferred.

The attended call transfer principle according to the invention is as follows. As in the case of the blind call transfer, terminal A dials a special access number of terminal B, also called service access number (SAN). The network routs the call from terminal A to terminal B by positioning in the signaling of the network a call identifier assigned by the SCP. This identifier is placed either in the NDS (Additional Designation Number) or UUS (User-to-User Signaling) field of the call signaling of the ISDN protocol. When the user of terminal B wishes to transfer the call to a terminal C of another user connected to the network 1, he puts the calling terminal A on hold on his equipment 5 and calls the server 3. When the server 3 answers the call, a call 12 between terminal B and the server 3 is established and the user of terminal B provides the server with the call identifier and the telephone number of terminal C to which the call is to be transferred. This information can be communicated in DTMF signals, in voice form or by means of data exchanged in the UUS signaling of the ISDN protocol. The server 3 then establishes a call 15 with terminal C and provides a connection 17 between the calls 12 and 15 so as to thereby establish the call between terminals B and C.

The user of terminal B can then carry out broker calls or a three-way conference between terminals A and C. It can also order the server 3, via DTMF signals, to transfer the calls in progress with optimization of the connections so as to maintain only one call between terminals A and C. Upon receipt of this transfer command, the server 3 transmits said command to the network which establishes the bridging of the half-call between terminal C and the network and the half-call between terminal A and the network, so as to put terminals A and C in communication. Simultaneously, the half-call between the network and terminal B is released after server 3 transmits a voice message of the transfer report. In terms of the network, the call between terminals A and B has therefore been transformed into a single call between terminals A and C.

FIG. 4a shows the procedure for establishing a call between terminals A and B in the case of an attended call transfer.

As described above, in the first step 51 of this procedure, the user of terminal A dials the special telephone number of terminal B. This special number is detected by the transit switch TS, which sends it to the SCP. In the next step 52, the SCP translates the special number received into a telephone number of terminal B, assigns an identifier to the call, and controls the transit switch TS so that it can establish a call between the local exchanges LE of terminals A and B. This operation results in the creation of a billing ticket 13 at the level of the transit switch or the SCP, and a call 11 between terminals A and B triggering the ringer of terminal B. If terminal B answers, it receives the NDS or UUS signaling containing the call identifier and is put in communication with terminal A (steps 53, 53′).

When the user of terminal B decides to transfer the call to terminal C, he orders, in step 54, his equipment 5 to place terminal A on hold, and dials the telephone number of the server 3 (step 55). This action results in the establishment of a call 12 at the network level between terminal B and the server 3. In the subsequent step 56, the server 3 answers and sends terminal B a voice message inviting the user to dial the call identifier received in step 53 and the number of the correspondent to whom the call is to be transferred.

In step 57, the user of terminal B dials the identifier of the call with terminal A and the telephone number of terminal C, using the keypad of the terminal, with a phone number extension (DTMF signals). This information is received in the next step 58 by the server 3 which calls terminal C using the telephone number received. In the next step 59, this call is routed by the SCP which controls the transit switch TS so that it can establish a call 15 between the server 3 and terminal C in conjunction with a new billing ticket 16.

The procedure continues as shown in FIG. 4b in the event of failure to establish a call with terminal C, i.e. if terminal C is busy or if the telephone number of terminal C is incorrect, or if terminal C does not answer after a predefined time period (step 61). In the next step 62, the SCP transmits a failure notice to the server 3. In the next step 63, the server 3 then transmits this failure notice in voice form to terminal B. The user of terminal B then has two options: either to repeat the procedure starting at step 57 by redialing the telephone number of terminal C or of another terminal, or to return to the conversation with the user of terminal A. This latter option is performed by releasing the call of terminal B with the server 3 (step 64) and by returning to the call with terminal A (step 56). Simultaneously, the server 3 decides after a predefined time period to terminate the call with terminal B (step 65).

If, after step 59, terminal C rings, the procedure will continue as shown in FIG. 4c. The server 3 detects it and transparently sends the call-back of terminal C to terminal B, by a connection 17 between the calls 12 and 15 from terminal B to the server and from the server to terminal C. If terminal C answers (step 69), terminals B and C are in communication with one another in steps 70, 70′ by means of the server 3.

In step 70′, the user of terminal B has the option of making broker calls between terminals A and B (FIG. 4d), hanging up or making a call-back (FIGS. 4e and 4g), and transmitting a transfer command (FIG. 4f).

In FIG. 4d, the user of terminal B in communication with terminal C via the server 3 transmits a broker call command to his equipment 5 (step 71). This action puts terminal C, which was in communication by means of server 3, on hold (steps 72, 72′), and puts terminal B in communication with terminal A (steps 73, 73′) . In this state, the user of terminal B can hang up or make a call-back (FIG. 4g), or transmit another broker call command (step 74). This latter action puts terminal A on hold (step 75), and puts terminal B in communication with terminal C by means of the server 3, returning to step 70.

In FIG. 4e, the user of terminal B is in communication with terminal C via the server 3, and hangs up or transmits a call-back command to his equipment 5 (step 81). This action causes the equipment 5 of terminal B to release the server (step 82) , which releases the call 15 with terminal C (step 83). Terminal B returns to the call with terminal A (step 84) and is in the same situation as in step 53. If terminal B hangs up, the call with terminal A is re-established by the equipment 5 of terminal B which represents this call to the user.

In FIG. 4f, the user of terminal B is in communication with terminal C via the server 3, and transmits a transfer request in step 91, for example, by pressing the “*#” keys of his terminal. This command is detected by the server 3 which in step 92 transmits, to the SCP, a transfer command so as to establish a call between terminals A and C, and release the calls to the server 3 and to terminal B. In the subsequent steps 93, 94, the SCP puts terminals A and C in communication by reorganizing the billing tickets 13 and 16 and releases the calls to terminal B and to the server 3. In the next steps 95, 95′, the terminals A and C are in communication.

In FIG. 4g, the user of terminal B is in communication with terminal A (steps 73, 73′), while the call with the server 3 is on hold on his equipment 5. In step 101, the user hangs up terminal B. This action causes the equipment 5 of terminal B to release the half-call of terminal B to terminal A, and represents the call of terminal B to terminal C via the server 3 (step 102). Simultaneously, the SCP indicates to the server 3 that the half-call to terminal B was released (step 103), and puts terminals A and C in communication by reorganizing the billing tickets 13 and 16 (step 105). Upon receipt of this signal, the server 3 releases the calls to terminal B, and the procedure continues as in step 95 in which terminals A and B are in direct communication.

An alternative to the invention, in which a call identifier is not assigned to the first call between terminals A and B, consists of carrying out a standard connection at the level of the equipment 5 between terminal A and the server 3. In a previous step, the call between terminals A and B has been marked in the network 1 to be rerouted to the server 3 at the end of the call between terminals A and B. The server 3, which has previously received a command for transfer to terminal C, carries out the release of the call to terminal B, which leads to the release of the call from terminal B to the network. The server then receives the call to terminal A, which it can then route to terminal C so as to carry out the transfer call.

However, this alternative makes it necessary to manage conflicts if this mechanism is implemented simultaneously for a plurality of calls. In this case, a plurality of calls to a terminal A can indeed be rerouted to the server. The server then actuates a time release so that the calls that are not rerouted are released when aborted by the originators. At the end of the time release, if the server has more than one call (with terminal A), they are then rerouted to their former correspondents (terminal B).

Although the description above refers to a STN telephone network, it goes without saying that the invention can also be implemented in a voice over IP telephone network in which the described functions of the SCP are carried out by a call server or a gatekeeper.

1. Call transfer method for transferring a call in progress between a first terminal (A) and a second terminal (B) by means of a telecommunication network (1), to a third terminal (C), which method includes preliminary steps in which the first terminal dials a telephone number of the second terminal, the number is processed by the network in order to route the call to the second terminal and thus establish a call between the first and the second terminal, characterized in that it includes steps in which:
the second terminal (B) puts the call with the first terminal (A) on hold, and calls a call transfer server (3) connected to the network (1),
once a call is established between the second terminal and the call transfer server, the second terminal provides the call transfer server with a telephone number of a third terminal (C) to which the call is to be transferred,
the call transfer server transmits to the network a command to establish a call with the third terminal, and
when the third terminal answers, it is put in communication with the first terminal, and the calls of the second terminal with the network and the call transfer server are interrupted.

2. Method according to claim 1, characterized in that, when the call is established between the first and the second terminal (A, B), the network (1) assigns a call identifier to the call, which identifier is transmitted to the second terminal, and once the call is established between the second terminal and the call transfer server (3), the second terminal provides the call transfer server with the identifier of the call between the first and the second terminal.

3. Method according to claim 2, characterized in that the network (1) assigns a call identifier to the call if the telephone number dialed by the first terminal is a special telephone number of the second terminal.

4. Method according to claim 2, characterized in that the identifier of the call between the first and the second terminal is transmitted to the second terminal (B) and to the call transfer server (3) in the call signaling of the ISDN protocol, or in the form of DTMF signals.

5. Method according to claim 1, characterized in that, after an order to establish a call with the third terminal (C) has been transmitted to the network (1), a call is established between the second terminal (B) and the third terminal by means of the call transfer server (3).

6. Method according to claim 5, characterized in that, after a broker call command has been transmitted by the second terminal (B), the second terminal switches between the call with the first terminal (A) and the call with the third terminal (C) by means of the call transfer server (3).

7. Call transfer server for transferring a call in progress between a first terminal (A) and a second terminal (B) by means of a telecommunication network (1), to a third terminal (C), characterized in that it includes processing means (20, 21) designed to:
receive a transfer command coming from the second terminal (B) by means of the network (1), which transfer command comprises a telephone number of a third terminal (C) to which the transfer is to be carried out,
transmit, to the network, a command to establish a call with the third terminal to which the transfer is to be carried out, after receiving the transfer command, and
detect the answering of the third terminal and, after this detection, order the network to establish the call between the third terminal and the first terminal, and to release the connection with the second terminal.

8. Call transfer server according to claim 7, characterized in that the processing means (20, 21) are also designed to receive, with the transfer command, an identifier of the call between the first and the second terminal (A, B).

9. Call transfer server according to claim 7, characterized in that the processing means (20, 21) are also designed to establish a call with the third terminal (C) and to put the latter in communication with the second terminal (B).

10. Call transfer server according to claim 7, characterized in that the processing means (20, 21) are also designed to transmit voice messages to the second terminal (B).

11. Call transfer server according to claim 7, characterized in that it includes means (22) for connecting to an intelligent network service control point (2) connected to the network (1), wherein the processing means (20, 21) are designed to send, to the service control point, call routing commands, call transfer commands, and call release commands, and to receive from the service control point call release signals and failure notices after an order to establish a call.

12. Terminal including:
means for connecting to a telecommunication network (1),
means for establishing a call with a second terminal by means of the telecommunication network, and
means for putting a call established with the second terminal by means of the telecommunication network on hold,
characterized in that it also includes:
means for receiving a call identifier after the call has been established with the second terminal, and
means for calling a call transfer server (3) connected to the network (1), and transmitting to it the call identifier, and a telephone number of a third terminal, after the second terminal has been put on hold.

13. Service control point (2) controlling a transit switch (TS) of a telecommunication network (1) so as to provide Intelligent Network services, including means for controlling the transit switch so that it can establish a call with a terminal connected to the network, by means of a local exchange LE of the network, to which the terminal is connected, characterized in that it also includes:
means for receiving a special telephone number transmitted by a first terminal in order to establish a call with a second terminal,
means for translating the special number received into a telephone number of the second terminal, and
means for assigning a call identifier to the call between the first and the second terminal, after the special number of the second terminal has been received.
